(19) United States
(12) Patent Application Publication
(10) Pub. No.: US 2002/0008971 A1
(43) Pub. Date: Jan. 24, 2002

(54) Lamp assembly

(76) Inventor: John McKenna, Lidcombe (AU)

Correspondence Address: PETER L COSTAS, PEPE & HAZARA LLP, 225 ASYLUM ST., HARTFORD, CT, 06103, US

(21) Appl. No.: 09/905,217

(22) Filed: Jul. 13, 2001

(30) Foreign Application Priority Data
Jul. 14, 2000 (AU) PQ8792

(51) Int. Cl. F21S 4/00

(52) U.S. Cl. 362/223; 362/377; 362/260; 362/217

(57) ABSTRACT

A lamp assembly for providing a safer means for handling of cold cathode fluorescent lamps wherein said lamp assembly comprises: (i) a cold cathode fluorescent lamp; (ii) a housing into which said cold cathode fluorescent lamp is placed; (iii) at least one end cap. In particular the present invention provides a lamp assembly for use with “EXIT” signage manufactured in accordance with recognized international codes or standards.

### BACKGROUND OF THE INVENTION

The present invention relates to a lamp assembly and in particular to Cold Cathode fluorescent lamps and their use in a lamp assembly. The lamp assembly of the present invention provides a safer means for handling of Cold Cathode fluorescent lamps.

Cold Cathode fluorescent lamps have been available for many years. Neon signs are one example of the early implementation of Cold Catholde fluorescent lamps. Smaller diameter Cold Catholde fluorescent lamps, down to 2.5 mm diameter, have been developed to provide a light source, for example as back lighting for laptop computers, document scanners, photocopiers and the like.

Cold Cathode fluorescent lamps have a single connection and generally do not require heating above ambient temperature to produce light. Cold Cathode fluorescent lamps may be custom made and can be contoured to almost any shape. Although widely used, the use of Cold Cathode fluorescent lamps has been restricted in its usage due largely to difficulties in handling smaller diameter lamps. For example, in EXIT signage, use of Cold Cathode fluorescent lamps is generally limited to edge lit diffuser panels in much the same way as laptops, although a 6 mm diameter Cold Cathode fluorescent lamp held in place with clips has been used in a “back lit” EXIT sign. In this case, the lamp has semi-exposed end connections.

The difficulty with utilizing Cold Cathode fluorescent lamps in a medium such as an EXIT sign is that difficulties may exist with respect to safety, lamp handling and replacement. An EXIT sign utilizing a Cold Cathode fluorescent lamp would usually operate the lamp on approximately 600 volts AC therefore, safety and handling difficulties arise due to the semiexposed lamp end connection, and the potential to break smaller diameter lamps.

For an EXIT sign, the relative dimensions, including size and spacing for each letter, size of the sign, colour and intensity of the light including the intensity of each of the letters, and the ratio of intensity between the illumination of each letter as opposed to the illumination of the background is regulated by Australian/New Zealand standard AS/NZS 2293, so the option for lighting is limited and regulated.

The discussion of the background to the invention herein is included to explain the context of the invention. This is not to be taken as an admission that any of the material referred to was published, known or part of the common general knowledge in Australia as at the priority date of this application.

It is a desirable feature of the present invention to provide a Cold Cathode fluorescent lamp that overcomes one or more of the difficulties associated with the prior art.

### SUMMARY OF THE INVENTION

The present invention relates to a lamp assembly including:

(i) a Cold Cathode fluorescent lamp;

(ii) a housing into which the Cold Cathode fluorescent lamp is placed; and

(iii) an end cap or caps.

The end caps seal the housing and provide for a means of connection of the lamp to the control gear.

### BRIEF DESCRIPTION OF THE DRAWINGS

FIG. 1 is a side elevational view of a Cold Cathode lamp assembly embodying the present invention; and

FIG. 2 is a front elevational view of an exit sign containing the Cold Cathode lamp assembly of FIG. 1.

### DETAILED DESCRIPTION OF TIHE ILLUSTRATED EMBODIMENT

The Cold Cathode fluorescent lamp is most preferably of a substantially elongated tubular configuration having a diameter of 1.8 mm to 6 mn. Most preferably the Cold Cathode fluorescent lamp is 2 to 3 mm in diameter.

The housing is most preferably glass tubing, but may also be tubing of a suitable plastic material, and is also of a substantially elongated tubular configuration. The housing should be of sufficient diameter to house the Cold Cathode fluorescent lamp comfortably within the housing. Preferably, the housing may have a diameter of from 5 mm to 38 mm, and most preferably bout 6 to 10 mm in diameter.

Generally, the diameter of the housing may be of such a diameter as to conform to a standard lamp classification. For example, the housing may have a T2 classification which indicates a diameter of two eighths of an inch. A T5 classification indicates the diameter is five eighths of an inch, and so on. The housing may conform to any standard size in accordance with standard classification.

The end cap or caps may be made of any standard material such as moulded plastic. Most preferably it is made of a one piece moulded plastic.

The end caps provide a means of holding the Cold Cathode fluorescent lamp within the housing and to provide a connection interface for the lamp with a lamp holder.

The Cold Cathode fluorescent lamp generally fits into the end caps via a recess in each end cap that is tailored with respect to the Cold Cathode fluorescent lamp diameter. This recess is preferably in the form of four diametrically opposed longitudinal finger sections that support the Cold Cathode fluorescent lamp concentrically within each end cap. The housing of the lamp assembly is also supported, preferably concentrically with each end cap by this finger detail. A Ultra Violet cure acrylic glue is preferably used and introduced via a filling hole in each end cap which provides the securing mechanism between the end cap and the housing. The Cold Cathode fluorescent lamp is free to move within the constraints of the finger recesses to allow for expansion/contraction of the lamp assembly during operation and to provide further shock protection during handling and transport. The connection wire from each end of the Cold Cathode fluorescent lamp is fed through a hole in the end of the end cap during this assembly process, and is formed back along the end cap towards the centre of the lamp assembly into a recess in the end cap, where it is then staked to the end cap.

A further embodiment is to assemble the Cold Cathode fluorescent lamp into a housing of different diameter from 4 mm diameter up to and including a T12 (38 mm) style, utilizing either a standard type single or two pin fluorescent end caps, or purpose designed end caps.

Generally, the length of the lamp and the housing is such to enable the lamp to fit within an EXIT sign in accordance with AS/NZS 2293. Cold Cathode fluorescent lamps in accordance with this invention are suitable for mounting either as a “back lit” light source for an EXIT sign, or as an “edge lit” light source having a diffuser panel to transmit the light source within the EXIT sign.

Preferably, the effective light length of the lamp assembly is from 280 to 380 mm, most preferably 297 mm. The overall length of the lamp assembly including end caps is 326 to 426 mm, most preferably 343 mm.

The lamp assembly preferably fits within an EXIT sign by engaging into lampholders that are usually attached to the housing or other part that attaches to the housing of the EXIT sign. In a preferred embodiment, the lamp assembly engages into a commercially available lampholder that is designed to accommodate a “T2” style conventional fluorescent lamp. These lampholders affix to a purpose designed “lampholder adapter.” This lampholder adapter then affixes to the frame of the EXIT sign. The use of these lampholder adapters is that the EXIT sign may be fitted with either the Cold Cathode fluorescent lamp assembly of the present invention, or with a conventional 10W T28 fluorescent lamp with lampholder adapters that accept standard T8 lampholders.

By placing the Cold Cathode fluorescent lamp within a housing such as a glass tube, and affixing the end caps, the lamp may be handled with a greater degree of safety than Cold Cathode fluorescent lamps that are currently available.

For a Cold Cathode fluorescent lamp to achieve optimum luminous efficacy, it should be operated in an ambient temperature of about 40-45° C. By surrounding the Cold Cathode fluorescent lamp with housing, the enclosure provides for an elevation in temperature above ambient. At 40-45° C., there is a greater luminous efficacy for a Cold Cathode fluorescent lamp of around 8-10% above that at 25° C. At approximately 55° C., the efficacy returns to the nominal point and decreases with increasing temperature.

The present invention enables a Cold Cathode fluorescent lamp to be used safely in a back lit or edge lit EXIT sign having regard to the potential safety concerns, such as physical injury from breakage or electric shock. The Cold Cathode fluorescent lamp assembly of the present invention may be readily replaced, handled, shipped and stored while providing an optimal operating environment for the Cold Cathode fluorescent lamp.

The lamp assembly in accordance with this invention may be used for any application, and in particular, where a lamp having a small diameter is desirable. A lamp assembly of smaller diameter allows for an EXIT sign to be reduced in depth whilst maintaining the variations of luminance across the face of the EXIT sign within the tolerance allowed by Australian/New Zealand standard AS/NZS 2293.

The present invention will now be described with reference to the accompanying drawings. These drawings are merely provided to illustrate preferred embodiments of the present invention, and the invention should not be considered to be limited thereto.

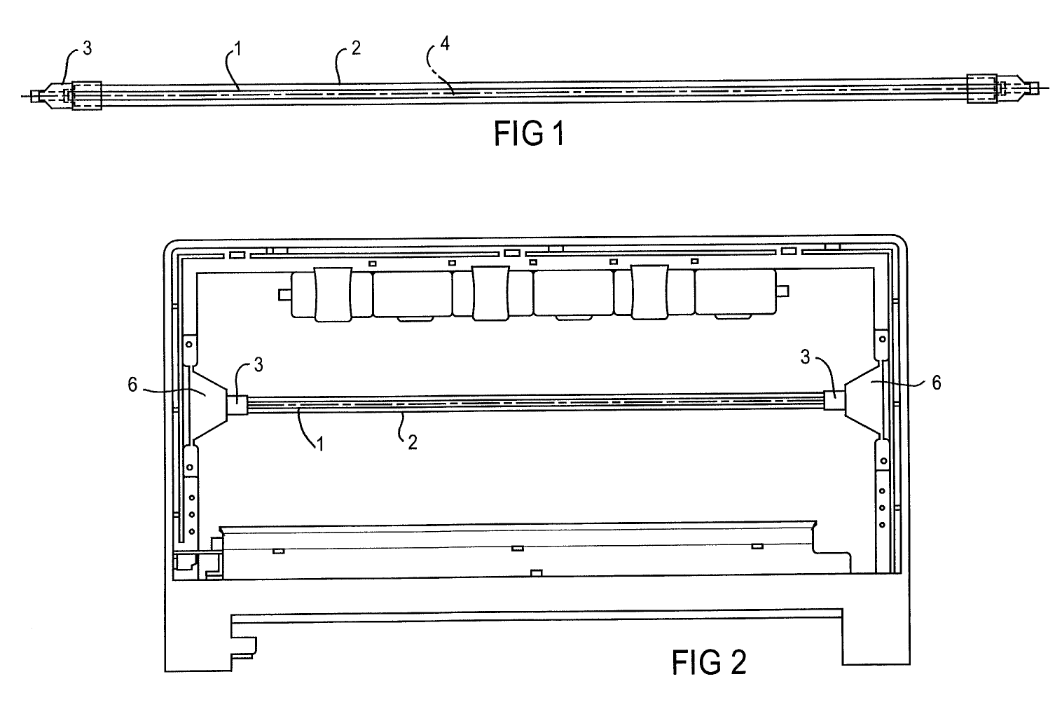

FIG. 1 illustrates a Cold Cathode fluorescent lamp 1 within a glass housing 2 end caps 3 are provided at each end of the glass housing. Wire 4 is heat sealed into a slot within the end cap at both ends of the Cold Cathode lamp to provide an electrical connection while ensuring that the connection is not exposed. The end caps also hold the lamp away from the housing.

FIG. 2 illustrates a Cold Cathode lamp of the invention fitted within an EXIT sign. The Cold Cathode fluorescent lamp 1 and glass housing 2 is shown in a position fitted with end caps 3 in holders 6 in a “back lit” EXIT sign.

It is to be understood that the embodiments described within the specification are merely preferable, and that alterations and amendments without departing from the spirit of the invention described herein should also be considered as part of the invention.

What is claimed is:

1. A lamp assembly wherein said lamp assembly comprises:
(i) a cold cathode fluorescent lamp;
(ii) a housing into which said cold cathode fluorescent lamp is placed; and
(iii) at least one end cap.

2. A lamp assembly according to claim 1 wherein said lamp assembly has two end caps.

3. A lamp assembly according to claim 1 wherein said end caps seal the housing and provide a means of connection of the fluorescent lamp to a controlling means.

4. A lamp assembly according to claim 2 wherein each of said end caps is made of a one piece moulded plastic.

5. A lamp assembly according to claim 1 wherein said end cap provides a means of holding the cold cathode fluorescent lamp within the housing and provide a connection interface for the lamp with a lamp holder.

6. A lamp assembly according to claim 1 wherein the cold cathode fluorescent lamp engages with the end cap by a recess in each end cap which is tailored with respect to the cold cathode fluorescent lamp diameter.

7. A lamp assembly according to claim 6 wherein the recess is in the form of four diametrically opposed finger sections which support the cold cathode fluorescent lamp substantially concentrically within each end cap.

8. A lamp assembly according to claim 7 wherein said finger sections also engage with the housing to support said housing substantially concentrically within each end cap.

9. A lamp assembly according to claim 8 wherein a securing means fixes the housing into position within the end caps.

10. A lamp assembly according to claim 9 wherein the securing means is an acrylic adhesive introduced through a hole in each end cap.

11. A lamp assembly according to claim 10 wherein the acrylic glue is an ultraviolet curing acrylic adhesive.

12. A lamp assembly according to claim 1 wherein said cold cathode fluorescent lamp is of a substantially elongated tubular configuration having a diameter of 1.8 mm to 6.0 mm.

13. A lamp assembly according to claim 12 wherein said cold cathode fluorescent lamp has a diameter of 2 to 3 mm.

14. A lamp assembly according to claim 1 wherein the housing is of a substantial elongated tubular configuration of sufficient diameter to comfortably house the cold cathode fluorescent lamp.

15. A lamp assembly according to claim 14 wherein the housing is tubing made of a material selected from the group consisting of glass and synthetic resin.

16. A lamp assembly according to claim 1 where the housing has a diameter of from 5 mm to 38 mm.

17. A lamp assembly according to claim 16 wherein the housing has a diameter from 6 mm to 10 mm.

18. A lamp assembly according to claim 1 wherein said end cap comprises a standard type single or two pin fluorescent end cap.

19. A lamp assembly according to claim 1 wherein reflective or diffusive material is incorporated in or applied to the lamp assembly.

20. A lamp assembly according to claim 1 wherein said lamp assembly further includes electronic control means to enable the lamp assembly to operate from a normal mains power source, or from a mains derived power source.

21. A lamp assembly according to claim 1 dimensioned to fit within standard EXIT signs in accordance with commonly used international standards.

22. A lamp assembly according to claim 21 wherein said lamp assembly is dimensioned to fit within an EXIT sign in accordance with AS/NZS 2293.

23. A lamp assembly according to claim 20 wherein the lamp assembly is held in position within said EXIT sign by one or more lampholders attached to or connected to the housing of the EXIT sign.
